(19) United States
(12) Patent Application Publication
(10) Pub. No.: US 2019/0054671 A1
(43) Pub. Date: Feb. 21, 2019

(54) METAL-PLASTIC COMPOSITE STRUCTURE FOR ELECTRONIC DEVICES

(71) Applicant: Hewlett-Packard Development Company, L.P., Houston, TX (US)

(72) Inventors: Kuan-Ting WU, Taipei (TW); Chi-Hao CHANG, Taipei (TW); Hung-Ming CHEN, Taipei (TW)

(73) Assignee: Hewlett-Packard Development Company, L.P., Houston, TX (US)

(21) Appl. No.: 15/770,563

(22) PCT Filed: Jan. 28, 2016
(86) PCT No.: PCT/US2016/015242

§ 371 Date: Apr. 24, 2018

(51) Int. Cl. B29C 45/14; B32B 15/08; C25D 11/02; B29C 45/16; B21D 26/055

(52) U.S. Cl. CPC B29C 45/14311; B32B 15/08; C25D 11/026; B29K 2705/00; B21D 26/055; B29C 2045/14868; B29C 45/1679

(57) ABSTRACT

In one example, a metal-plastic composite structure for an electronic device is described, which includes a micro-arc oxidized metal substrate and at least one plastic film disposed on the micro-arc oxidized metal substrate using a superplastic forming process.

### BACKGROUND

In recent years, metal housings with lightweight and high rigidity properties have become popular since the portable electronic products are developed to be lighter, shorter and smaller. In such requirements, the technology of composite material that combines metal housing with plastic members has become a main focus in the industry. To make the electronic devices more fashionably and aesthetically appealing to users, metal housings of portable electronic devices may be coated with plastic films to form a decorative layer on the outer surfaces. The plastic films may also serve as a protective layer and may prevent damage to the metal housing when disposed on a metallic substrate/material.

### BRIEF DESCRIPTION OF THE DRAWINGS

Examples are described in the following detailed description and in reference to the drawings, in which:

FIGS. 1A and 1B illustrate a perspective view of an example metal-plastic composite structure formed using a superplastic forming process, according to one aspect of the present subject matter;

FIG. 2 illustrates an example flowchart for manufacturing an electronic device housing using a superplastic forming process, according to one aspect of the present subject matter;

FIG. 3 illustrates an example flowchart for forming a metal-plastic composite structure using a superplastic forming process, according to one aspect of the present subject matter;

FIG. 4 illustrates an example superplastic forming process to transform a superplastic material, such as a metal substrate, into a desired shape, in the context of the present subject matter;

FIGS. 5A-5C illustrate another example superplastic forming process to dispose at least one plastic film on the exposed micro-arc oxidized metal substrate, according to one aspect of the present subject matter;

FIG. 6 is a perspective view of an example electronic device showing a negative angle geometry, in the context of the present subject matter; and

FIGS. 7 and 8 illustrate example processes for fabricating metal-plastic composite structure for electronic devices, according to one aspect of the present subject matter.

### DETAILED DESCRIPTION

To make the electronic devices more fashionably and aesthetically appealing to users, metal housings of portable electronic devices may be coated with plastic films to form a decorative layer on the outer surfaces. Some examples may use in-mold decoration (IMD), out-side mold decoration (OMD), in-mold film (IMF) or nano-imprint lithography process, which may be unable to have a negative angle formation and may not cover the non-surface finish on the bottom of the metal substrate.

Examples described herein may develop patterned or non-patterned plastic films on micro-arc oxidized metal surfaces by superplastic forming to form complex shapes and integrated structures with precision and a fine surface finish. In one example, a metal-plastic composite structure for electronic devices may include a micro-arc oxidized metal substrate and at least one plastic film disposed on the micro-arc oxidized metal substrate using a superplastic forming process. Example metal-plastic composite structure includes an electronic device metal housing. The micro-arc oxidized metal substrate includes a metal substrate and a micro-arc oxide layer formed on the metal substrate.

In another example, a method for manufacturing a metal-plastic composite structure (e.g., electronic device housing) is provided. A metallic substrate is provided. Further, a micro-arc oxide layer is formed on the metallic substrate. Then, at least one plastic film is disposed on the exposed micro-arc oxide layer using a first superplastic forming process. The first superplastic forming process may be carried out at an operational temperature in the range of 60° C. to 350° C. and an operational pressure in the range of 15 kg/cm² to 100 kg/cm². The superplastic forming may be a hot forming process in which sheets of superplastic grade materials (e.g., metal/plastic) are heated and forced onto or into single surface tools by air/gas pressure. For example, the plastic film is heated to an operational temperature in the range of 60° C. to 350° C. and then an operational pressure in the range of 15 kg/cm² to 100 kg/cm² is applied to attach the plastic film to the micro-arc oxidized metal substrate.

Examples described herein may envelope the substrates by plastic films. Examples described herein may provide a lighter and stronger metal-plastic composite structures and enable to form complex shapes and integrated structures. Examples described herein may provide an excellent precision and a fine surface finish (e.g., <5 μm) and offer a short forming cycle time (e.g., <15 minutes). Examples described herein may involve a single die to make metal-plastic composite structure as opposed to deep drawing processes and may have less tooling costs. Examples described may achieve low border radius (e.g., on cover edge, which the stamping may be unable to achieve with sharp edge fabrication. Examples described may have multiple textures in a single metal-plastic composite product.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

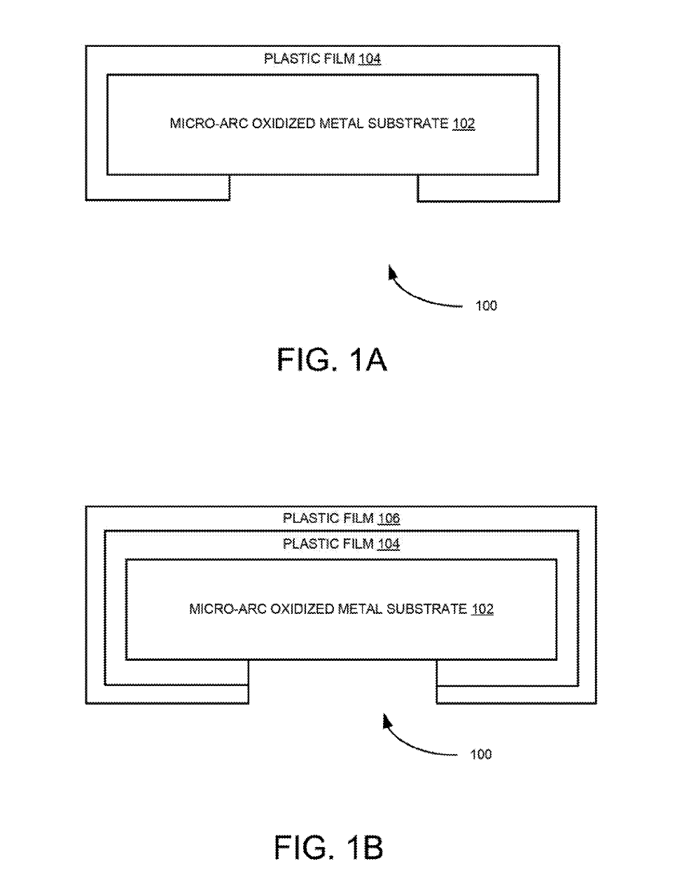

Turning now to the figures, FIGS. 1A and 1B illustrate a perspective view of an example metal-plastic composite structure 100 formed using a superplastic forming process, according to one aspect of the present subject matter. Example metal-plastic composite structure 100 may include a smart phone housing, tablet or notebook personal computer housing, digital camera housing and the like. Metal-plastic composite structure 100 includes a micro-arc oxidized metal substrate 102 and a plastic film 104 disposed on micro-arc oxidized metal substrate 102. In one example, plastic film 104 is disposed on micro-arc oxidized metal substrate 102 using a superplastic forming process. For example, plastic film 104 may cover/envelope micro-arc oxidized metal substrate 102 and can become an integral and permanent part of metal-plastic composite structure 100, through thermal and high-pressure vacuum transfer.

Micro-arc oxidized metal substrate 102 may include a metal substrate and a micro-arc oxide layer formed on the metal substrate. Micro-arc oxidized metal substrate 102 may include properties such as wearing resistance, corrosion resistance, high hardness and electrical insulation. Example metal substrate is made up of at least one material selected from a group consisting of aluminum, magnesium, lithium, zinc, titanium, aluminum alloy, magnesium alloy, lithium alloy, zinc alloy and titanium alloy.

Example plastic film 104 is made up of at least one plastic material selected from a group consisting of polyacrylnitrile, polyethylene, polypropylene, polystyrene, polyvinylacetate, poly(meth)acrylate, polyvinylchloride, fluropolymer, chlorinated polyether, polyurethane, polyamide, polycarbonate, polyester, polyimide, polyphthalamide, polyphenylene sulfide and polysulphone.

Further, plastic film 104 may include at least one filler selected from a group consisting of carbon black, titanium dioxide, clay, mica, talc, barium sulfate, calcium carbonate, synthetic pigment, dye, metallic powder, aluminum oxide, graphene and dispersed elastomers. In the example shown in FIG. 1A, metal-plastic composite structure 100 is formed using one plastic film 104, however, any number of plastic films can be disposed on micro-arc oxidized metal substrate 102 using the superplastic forming process. For example, FIG. 1B illustrates metal-plastic composite structure 100, in which a plastic films 104 and 106 are disposed on micro-arc oxidized metal substrate 102 using the superplastic forming process.

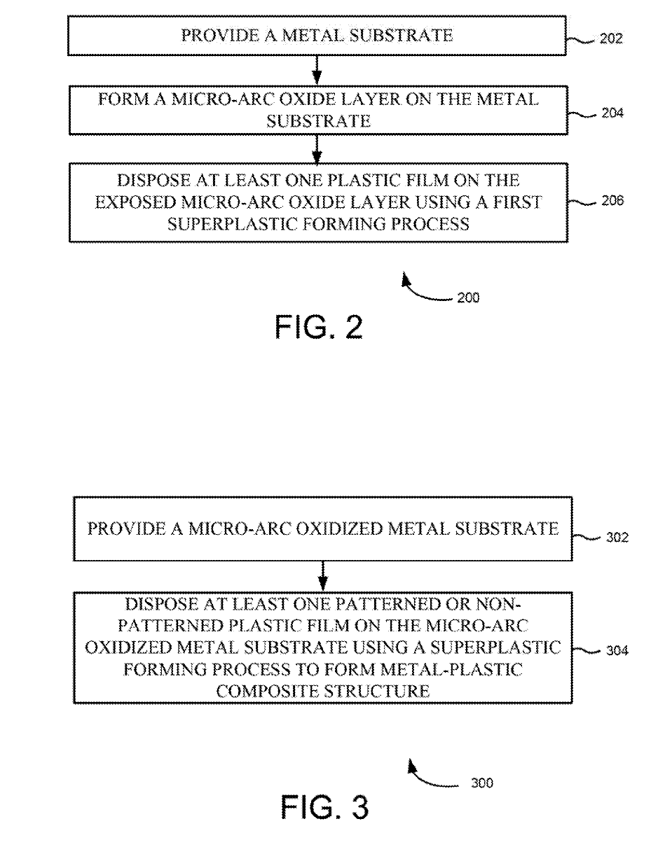

FIG. 2 illustrates an example flowchart 200 for manufacturing an electronic device housing using a superplastic forming process, according to one aspect of the present subject matter. At 202, a metal substrate is provided. Example metal substrate is made up of at least one material selected from a group consisting of aluminum, magnesium, lithium, zinc, titanium, aluminum alloy, magnesium alloy, lithium alloy, zinc alloy and titanium alloy. At 204, a micro-arc oxide layer is formed on the metal substrate. For example, the micro-arc oxide layer is formed on the metal substrate using a micro-arc oxidation (MAO) process, which may be an electrochemical surface treatment process for generating oxidecoatings on metals.

For example, in MAO process, a light metal sheet/metal substrate may be placed in an electrolytic solution including electrolytes selected from a group consisting of sodium silicate, sodium phosphate, potassium fluoride, potassium hydroxide, sodium hydroxide, fluorozirconate, sodium hexametaphosphate, sodium fluoride, aluminum oxide, silicon dioxide, ferric ammonium oxalate, phosphoric acid salt, polyethylene oxide alkylphenolic ether and combinations thereof. During the MAO surface treatment, the electrolyte may be present in a concentration of 0.05 to 15% by weight based on the total weight of the electrolytic solution and a voltage in the range of 200-600 V may be passed across the electrolytic solution with the metal substrate (e.g., magnesium-based alloy substrate) placed in the electrolytic solution to form the micro-arc oxidized layers. In one example, the voltage may be applied for about 3 to 20 minutes and the MAO process can be carried out at a temperature between room temperature and 45° C. The thickness of the micro-arc oxide layer can be in the range of 3-15 μm. The micro-arc oxidation properties may include wearing resistance, corrosion resistance, high hardness and electrical insulation.

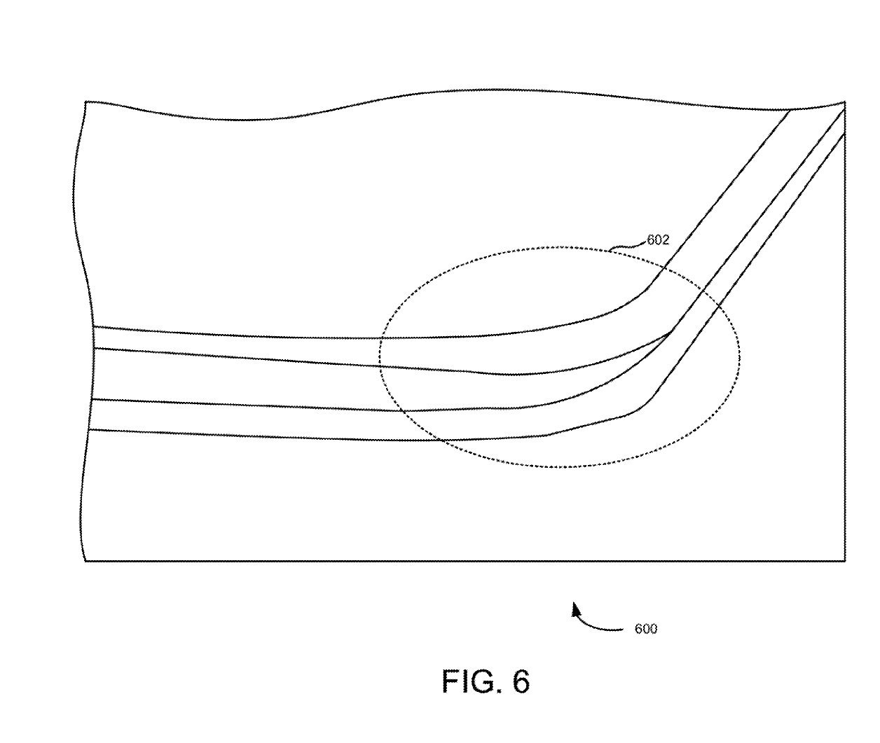

At 206, at least one plastic film is disposed (e.g., attached/transferred/applied) on the exposed micro-arc oxide layer using a first superplastic forming process. For example, the first superplastic forming process may be carried out at an operational temperature in the range of 60° C. to 350° C. and an operational pressure in the range of 15 kg/cm² to 100 kg/cm². The thickness of the at least one plastic film can be in the range of 15 μm to 0.3 mm, preferably between 15 to 45 μm. The first superplastic forming process for attaching the plastic film to the micro-arc oxidized metal substrate is explained n detail in FIGS. 5A-5C.

Example plastic film is made up of at least one plastic material selected from a group consisting of polyacrylnitrile, polyethylene, polypropylene, polystyrene, polyvinylacetate, poly(meth)acrylate, polyvinylchloride, fluropolymer, chlorinated polyether, polyurethane, polyamide, polycarbonate, polyester, polyimide, polyphthalamide, polyphenylene sulfide and polysulphone.

Further, the plastic film may include at least one filler selected from a group consisting of carbon black, titanium dioxide, clay, mica, talc, barium sulfate, calcium carbonate, synthetic pigment, dye, metallic powder, aluminum oxide, graphene and dispersed elastomers. For example, the amount of the at least one filler can be up to 25% by weight or 5 to 20% by weight based on the total weight of the plastic layer.

Further, the metal substrate is cleaned before forming a mica-arc oxide layer on the metal substrate. The cleaning of the metal substrate includes a pre-cleaning process, such as an alkaline cleaning process, degreasing cleaning process or an acidic cleaning process.

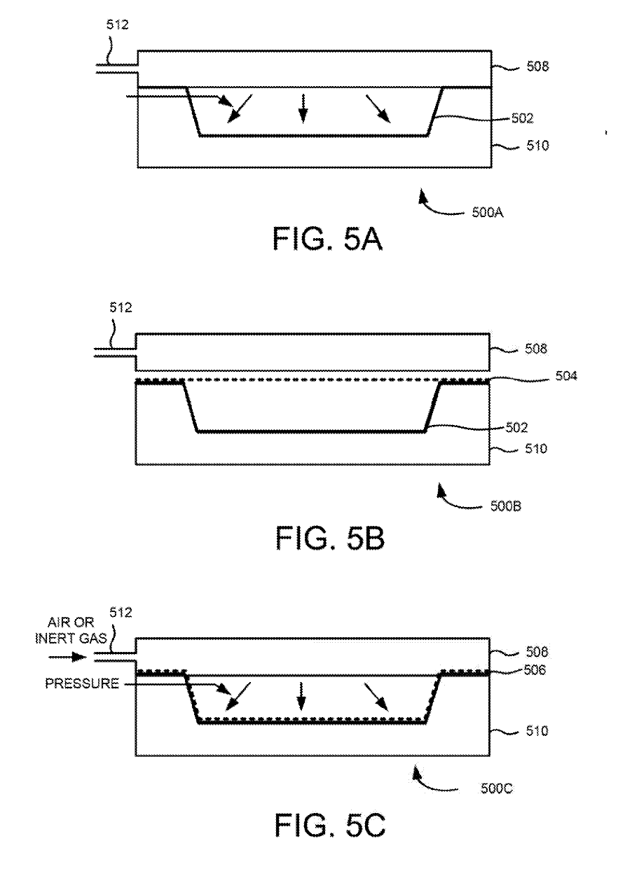

In one example, the metal substrate is forged, die casted or Computer Numeric Control (CNC) machined into a desired shape before cleaning the metal substrate. In another example, the metal substrate is formed into a desired shape using a second superplastic forming process before forming a micro-arc oxide layer on the metal substrate and after cleaning the metalsubstrate. The second superplastic forming process is carried out at an operational temperature in the range of 350° C. to 600° C. and an operational pressure in the range of 60 kg/cm² to 180 kg/cm². The second superplastic forming process to transform the metal substrate into a desired shape is explained in detail in FIG. 4.

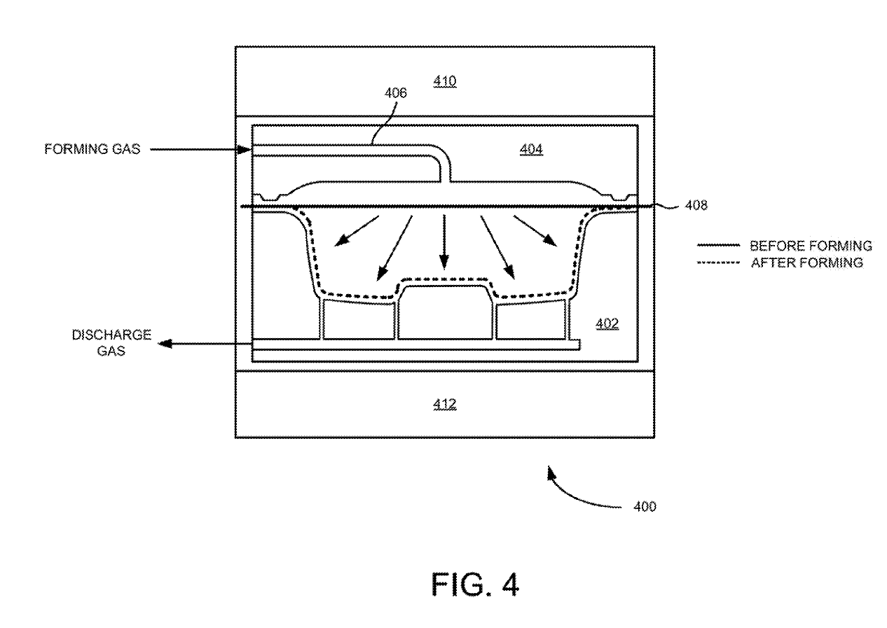

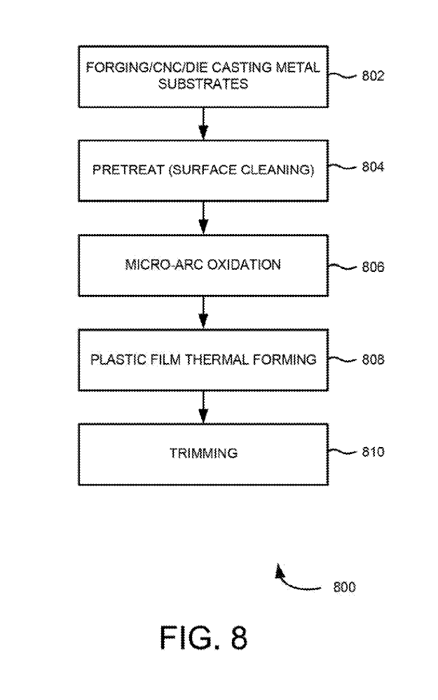

FIG. 3 illustrates an example flowchart 300 for forming a metal-plastic composite structure using a superplastic forming process, according to one aspect of the present subject matter. At 302, a micro-arc oxidized metal substrate is provided. In one example, the micro-arc oxidized metal substrate includes a metal substrate, and a micro-arc oxide layer formed on the metal substrate using the MAO process. In one example, providing the metal substrate includes forging, die casting or CNC machining the metal substrate into a desired shape before cleaning the metal substrate. This is explained in detail in FIG. 7. In another example, the metal substrate is transformed into a desired shape using a second superplastic forming process before forming a micro-arc oxide layer on the metal substrate and after cleaning the metal substrate. This is explained in detail in FIG. 8.

At 304, at least one patterned or non-patterned plastic film is disposed on the micro-arc oxidized metal substrate using a first superplastic forming process to form the metal-plastic composite structure. Example patterned plastic film can include a 3-dimensional pattern, knitting bamboo pattern or fish scale pattern.

Referring now to FIG. 4, which illustrates an example superplastic forming process 400 to transform a superplastic material, such as a metal substrate 408, into a desired shape. Example superplastic forming process described in FIG. 4 is used for sheet metal design. Superplastic forming for metal substrate is a method for producing simple and complex components. In operation, metal substrate 408 (e.g., magnesium sheet) may be nestled between a top cover 404 and a die cavity 402 that can be sealed to top cover 404. For example, top cover 404 and die cavity 402 may be clamped together using an upper platen 410 and a lower platen 412. Top cover 404 may include an inlet branch 406 that makes diffusion of forming gas (e.g., air, inert gas and the like). In one example, metal substrate 408 is heated to a superplastic forming temperature using heating elements disposed in top cover 404, and then inlet branch 406 unleashes the forming gas with a high pressure. For example, metal substrate 408 is heated to the superplastic forming temperature (e.g., between 350° C. to 600° C. depending on the type of metal substrate 408) within a sealed die. Forming gas pressure is then applied, at a controlled rate forcing metal substrate 408 to take the shape of the die pattern. In this case, metal substrate 408 deforms and changes the shape to the shape of the diecavity 402. The elongation at break of a metal substrate 408 can be in a range of 5 to 50%. The discharge gas may be expelled out through a vent/outlet. FIG. 4 illustrates metal substrate 408 before and after forming applying the superplastic forming.

Referring to FIGS. 5A-5C, which illustrate an example superplastic forming process to attach at least one plastic film to the exposed micro-arc oxide layer, according to one aspect of the present subject matter. FIGS. 5A-5C may include a top cover 508 and a bottom cover 510. Process 500A illustrates metal substrate 502 disposed inside bottom cover 510. Process 500B illustrates placing a plastic film 504 between top cover 508 and bottom cover 510. The top cover 508 is then sealed to bottom cover 510 via plastic film 504. Further, top cover 508 can include an inlet branch 512 above plastic film 504 to make diffusion of forming gas (e.g., air, inert gas and the like). After heating up plastic film 504 to a temperature between 60° C. to 350° C. depending on the type of plastic film, the inlet branch 512 unleashes the forming gas with a pressure in the range of 15 kg/cm² to 100 kg/cm², at a controlled rate, to attach plastic film 504 to metal substrate 502 (i.e., to form fully adhered plastic film 506 as shown in process 500C). The plastic film thus formed can become an integral and permanent part of metal substrate 502. In one example, the first and second superplastic forming processes as described in FIGS. 4 and 5, respectively, can be carried out in a single die cavity.

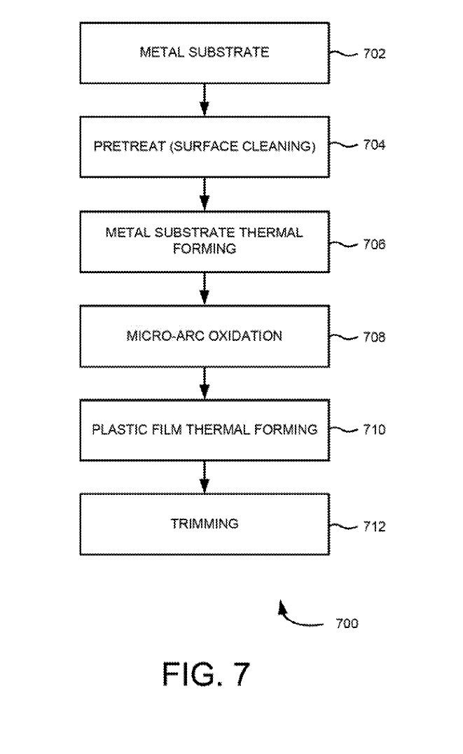

FIG. 6 is a perspective view of an example electronic device 600 showing a negative angle geometry 602. The metal-plastic composite structure formed using the MAO and superplastic forming processes can have a negative angle formation and may cover the non-surface finish on the bottom of the metal substrate.

FIG. 7 illustrates an example process 700 for forming metal-plastic composite structure, in which a metal substrate is formed into a desired shape using a superplastic forming process. At 702, a metal substrate (e.g., a metal sheet) is provided. At 704, the metal substrate is pretreated using a pre-cleaning process. At 706, a metal substrate thermal forming (e.g., second superplastic forming as described in FIG. 4) is applied to the metal substrate to convert/transform the metal substrate into a desired shape. At 708, the micro-arc oxide layer is formed on the metal substrate using the MAO process. At 710, a plastic film is applied on the exposed micro-arc oxide layer using a first superplastic forming process (e.g., as described in FIGS. 5A-5C) to form the metal-plastic composite structure. At 712, the plastic film in the metal-plastic composite structure is trimmed to remove any unwanted portions.

FIG. 8 illustrates another example process 800 for forming metal-plastic composite structure, in which a metal substrate is formed into a desired shape by forging, die casting or CNC machining. At 802, a metal substrate is formed into a desired shape by forging, die casting or CNC machining. At 804, the metal substrate is pretreated using a pre-cleaning process. At 806, the micro-arc oxide layer is formed on the metal substrate using the MAO process. At 808, a plastic film is applied on the exposed micro-am oxide layer using a first superplastic forming process (e.g., as described in FIGS. 5A-5C) to form the metal-plastic composite structure. At 810, the plastic film in the metal-plastic composite structure is trimmed to remove any unwanted portions.

In this manner, the present application discloses a metal-plastic composite structure formed by applying a plastic film to a micro-arc oxidized metal substrate using a superplastic forming process, in which the non-surface finish on the bottom of the metal substrate can be covered.

The foregoing describes novel metal-plastic composite structure formed by superplastic forming process. While the above application has been shown and described with reference to the foregoing examples, it should be understood that other forms, details, and implementations may be made without departing from the spirit and scope of this application.

What is claimed is:

1. A metal-plastic composite structure for an electronic device comprising:
a micro-arc oxidized metal substrate; and
at least one plastic film disposed on the micro-arc oxidized metal substrate using a superplastic forming process.

2. The metal-plastic composite structure of claim 1, herein the micro-arc oxidized metal substrate comprises:
a metal substrate; and
a micro-arc oxidelayer formed on the metal substrate.

3. The metal-plastic composite structure of claim 2, wherein the metal substrate comprises at least one material selected from a group consisting of aluminum, magnesium, lithium, zinc, titanium, aluminum alloy, magnesium alloy, lithium alloy, zinc alloy, and titanium alloy.

4. The metal-plastic composite structure of claim 1, wherein the plastic film is made up of at least one plastic material selected from a group consisting of polyacrylnitrile, polyethylene, polypropylene, polystyrene, polyvinylacetate, poly(meth)acrylate, polyvinylchloride, fluropolymer, chlorinated polyether, polyurethane, polyamide, polycarbonate, polyester, polyimide, polyphthalamide, polyphenylene sulfide, and polysulphone.

5. The metal-plastic composite structure of claim 1, wherein the plastic film comprises at least one filler selected from a group consisting of carbon black, titanium dioxide, clay, mica, talc, barium sulfate, calcium carbonate, synthetic pigment, dye, metallic powder, aluminum oxide, graphene and dispersed elastomers.

6. A method for manufacturing an electronic device housing, the method comprising:
providing a metal substrate;
forming a micro-arc oxide layer on the eta substrate; and
disposing at least one plastic film on the exposed micro-arc oxide layer using a first superplastic forming process.

7. The method of claim 6, wherein the first superplastic forming process comprises an operational temperature in the range of 60° C. to 350° C. and operational pressure in the range of 15 kg/cm² to 100 kg/cm².

8. The method of claim 6, further comprising:
cleaning the metal substrate before forming the micro-arc oxide layer on the metal substrate, wherein cleaning of the metal substrate comprises pre-cleaning process, and wherein the pre-cleaning process comprises an alkaline cleaning process, degreasing cleaning process or an acidic cleaning process.

9. The method of claim 8, further comprising:
forging, die casting or Computer Numeric Control (CNC) machining the metal substrate into a desired shape before cleaning the metal substrate.

10. The method of claim 8, further comprising:
forming the metal substrate into a desired shape using a second superplastic forming process before forming the micro-arc oxide layer on t metal substrate and after cleaning the metal substrate.

11. The method of claim 10, wherein tie second superplastic forming process comprises an operational temperature in the range of 350° C. to 600° C. and an operational pressure in the range of 60 kg/cm² to 180 kg/cm².

12. A method for forming metal-plastic composite structure, the method comprising:
providing a micro-arc oxidized metal substrate; and
disposing at least one patterned or non-patterned plastic film on the micro-arc oxidized metal substrate using a first superplastic forming process to form the metal-plastic composite structure.

13. The method of claim 12, wherein in providing the micro-arc oxidized metal substrate, the micro-arc oxidized metal substrate is formed by:
providing a metal substrate;
pre-cleaning the metal substrate; and
forming a micro-arc oxide layer on the metal substrate.

14. The method of claim 13, wherein providing the metal substrate comprises:
forging, die casting or Computer Numeric Control (CNC) machining the metal substrate into a desired shape before cleaning the metal substrate.

15. The method of claim 13, further comprising:
forming the metal substrate into a desired shape using a second superplastic forming process before forming the micro-arc oxide layer on the metal substrate and after cleaning the metal substrate.
